(19) United States
(12) Patent Application Publication
(10) Pub. No.: US 2012/0169701 A1
(43) Pub. Date: Jul. 5, 2012

(54) READOUT INTEGRATED CIRCUIT FOR A TOUCH SCREEN

(75) Inventors: Young Suk Son, Daejeon-si (KR); Hyung Seog Oh, Daejeon-si (KR); Dae Keun Han, Daejeon-si (KR); Gyu Hyeong Cho, Gongju-si (KR); Jun Hyeok Yang, Daegu-si (KR); Seung Chul Jung, Gwangju-si (KR)

(73) Assignees: Korea Advanced Institute of Science and Technology (KAIST), Daejeon-si (KR); SILICON WORKS CO., LTD, Daejeon-si (KR)

(21) Appl. No.: 13/394,696

(22) PCT Filed: Sep. 1, 2010
(86) PCT No.: PCT/KR2010/005905

§ 371 Date: Mar. 7, 2012

(30) Foreign Application Priority Data
Sep. 8, 2009 (KR) 10-2009-0084609

(51) Int. Cl. G09G 5/00

(52) U.S. Cl. 345/211

(57) ABSTRACT

A readout integrated circuit (ROIC) for a touch screen, the readout integrated circuit includes: a touch sensor unit configured to include a plurality of touch sensors which are arranged in a matrix form having rows and columns in an inside or outside of a touch screen panel (TSP); a plurality of sensing blocks configured to sense an electrical change in each of the touch sensors, to convert the electrical change into a voltage value, and to store the voltage value; a delta circuit unit configured to receive a difference between two sensing voltage values stored in two sensing blocks, respectively, which are spaced by a predetermined distance and selected from among the plurality of sensing blocks, and to produce a delta (Δ) voltage; and an analog-to-digital converter configured to convert an analog signal output from the delta circuit unit into an N-bit digital signal (wherein, “N” is a natural number).

### BACKGROUND OF THE INVENTION

1. Field of the Invention

The present invention relates to a readout circuit for a touch screen, and more particularly, to a readout circuit for a touch screen which detects edges of touch regions based on a sigma-delta principle.

2. Description of the Related Art

Recently, in order to remove cumbersome input devices, such as keyboards, mice, and buttons, and to enable a wider area to be utilized for display, various products having a touch function have been put on the display market. Such touch screen panels (TSPs) are classified into a resistive type, a capacitive type, and a photo-sensor type according to the types of touch sensors.

A touch screen employing a resistive-type touch screen panel (TSP) uses a technology that finds position information by detecting a voltage value by means of a resistive film when the user touches a partial area of the touch screen panel. The resistive-type touch screen panel has advantages of low cost and easiness of miniaturization, which allows the resistive-type touch screen panel to have occupied most of the touch screen market until now. However, the resistive-type touch screen panel has disadvantages in that it has a low contrast ratio due to a plurality of indium tin oxide (ITO) layers, it is weak in abrasion and scratch resistance, and it is difficult to implement multi-touch.

Accordingly, recently, the capacitive-type and the photo-sensor-type touch screen panels have been highlighted as a touch screen panel to replace the resistive-type touch screen panel.

FIG. 1 is a view illustrating the conception of a conventional readout integrated circuit (ROIC) for a touch screen using a capacitive scheme or photo-sensor scheme.

Referring to FIG. 1, a readout integrated circuit (ROIC) of a conventional touch screen includes a touch screen panel (TSP) 100, touch sensors 113 arranged in the form of a matrix having rows and columns, and an analog-to-digital converter (ADC) 130.

According to the conventional technology, whether or not a touch is generated is determined in such a manner as to map analog values of coordinates of the touch sensors 113 to digital values in one-to-one correspondence through the analog-to-digital converter 130.

When one analog-to-digital converter 130 for every column is used, various problems occur in terms of power consumption, area, etc. Therefore, generally, one analog-to-digital converter 130 is configured to cover a large number of touch sensors 113. That is, in step 1, when one row is selected, all the touch sensors 115 of the selected row generate analog voltage values through a sensing block, and store the analog voltage values in a sampling capacitor. In step 2, the analog voltage values stored in the sampling capacitor are sequentially read in such a manner as to scan columns of the row one by one, and an analog-to-digital conversion is performed on the analog voltage values, thereby detecting a touch area. While step 2 is performed, the operation corresponding to step 1 is performed with respect to the next row. In step 3, the next row is selected, and the operation corresponding to step 2 is performed with respect to the selected next row. In such a manner, these steps are repeatedly performed with respect to all rows.

FIG. 2 is a circuit illustrating the configuration of a conventional readout integrated circuit (ROIC) for a touch screen using a capacitive scheme or photo-sensor scheme.

Referring to FIG. 2, the conventional readout integrated circuit 200 for a touch screen includes column readout circuits 210a and 210b arranged in each column of a touch screen panel, a global charge amplifier 220, and an analog-to-digital converter (ADC) 230.

Since a plurality of column sensing blocks are connected to an upper line nx1 of a common and a low line nx2 of the common line, charge stored in sampling capacitors Cs and Cr may be lost due to a parasitic capacitor Cx1 213a of the upper line and a parasitic capacitor Cx2 213b of the lower line before the charge is input into the analog-to-digital converter (ADC) 230. The global charge amplifier 220 is used such a charge loss.

The global charge amplifier 220 charges the upper line nx1 and the low line nx2 with charge of the sampling capacitors Cs and Cr, respectively, through the use of a feedback-connected operational amplifier (OP Amp), thereby preventing a common-mode voltage of the common line from being changed.

FIG. 3 is a view illustrating an equivalent circuit of the conventional global charge amplifier for explaining the principle of the conventional global charge amplifier.

Referring to FIG. 3, since C_{A} is shown as AC_{A} due to the Miller effect, a lower circuit in FIG. 3 is analyzed to be an equivalent circuit of an upper circuit in FIG. 3, so that the output voltage V_{O} of the amplifier is expressed as Equation 1 below.

$${V}_{O} = \frac{A \cdot {Q}_{0}}{{C}_{S} + {C}_{P} + A \cdot {C}_{A}} = \frac{{Q}_{0}}{{C}_{A} + ( {C}_{S} + {C}_{P} ) / A} \qquad ( 1 )$$

Here, C_{S} denotes a storage capacitor of an output terminal of a sensing block, C_{P} denotes a parasitic capacitance of a common line, C_{A} denotes a feedback capacitor of a global charge amplifier, and “A” denotes a gain of the global charge amplifier.

However, the conventional global charge amplifier has problems as below.

First, the global charge amplifier requires an operational amplifier (OP Amp) having a broad bandwidth, and requires a common-mode feedback (CMFB) circuit to stabilize the common mode of an output terminal due to the characteristics of a differential structure, so that it is complicated to design the operational amplifier (OP Amp).

Second, it is necessary for the node impedance of the common line to have a small value in order to stabilize the common-line node, but the impedance is fixed at 1/Gₘ or so when a general operational transconductance amplifier (OTA) is employed. Here, Gₘ denotes the transconductance of the OTA itself.

### SUMMARY OF THE INVENTION

Accordingly, the present invention has been made in an effort to solve the problems occurring in the related art, and an object of the present invention is to provide a readout integrated circuit (ROIC) for a touch screen, which detects an edge of a touched area while maximally reducing a noise component exerting an influence on a sensing operation based on a sigma-delta principle, remarkably reduces the resolution of analog-to-digital converter (ADC) so that the readout integrated circuit (ROIC) requiring low power and small area can be manufactured, and includes a new charge amplifier having a simple structure and a broad bandwidth.

In order to achieve the above object, according to one aspect of the present invention, there is provided a readout integrated circuit (ROIC) for a touch screen, the readout integrated circuit including: a touch sensor unit configured to include a plurality of touch sensors which are arranged in a matrix form having rows and columns in an inside or outside of a touch screen panel (TSP); a plurality of sensing blocks configured to sense an electrical change in each of the touch sensors, to convert the electrical change into a voltage value, and to store the voltage value; a delta circuit unit configured to receive a difference between two sensing voltage values stored in two sensing blocks, respectively, which are spaced by a predetermined distance and selected from among the plurality of sensing blocks, and to produce a delta (Δ) voltage; and an analog-to-digital converter (ADC) configured to convert an analog signal output from the delta circuit unit into an N-bit digital signal (wherein, “N” is a natural number).

### BRIEF DESCRIPTION OF THE DRAWINGS

The above objects, and other features and advantages of the present invention will become more apparent after a reading of the following detailed description taken in conjunction with the drawings, in which:

FIG. 1 is a view illustrating the conception of a conventional readout integrated circuit (ROIC) for a touch screen using a capacitive scheme or photo-sensor scheme;

FIG. 2 is a circuit illustrating the configuration of a conventional readout integrated circuit (ROIC) for a touch screen using a capacitive scheme or photo-sensor scheme;

FIG. 3 is a view illustrating an equivalent circuit of the conventional global charge amplifier for explaining the principle of the conventional global charge amplifier;

FIG. 4 is a view illustrating a conception of a readout integrated circuit (ROIC) for a touch screen based on a sigma-delta principle according to an embodiment of the present invention;

FIG. 5 is a circuit illustrating the configuration of a readout integrated circuit (ROIC) for a touch screen based on a sigma-delta principle, which is configured to process a 1-bit signal, according to an embodiment of the present invention;

FIG. 6 is a circuit of a dead-zone comparator in which it is possible to adjust a dead zone by varying current according to an embodiment of the present invention;

FIG. 7 is a circuit illustrating the configuration of a readout integrated circuit (ROIC) for a touch screen based on a sigma-delta principle, which is configured to process a multi-bit signal having two or more bits, according to an embodiment of the present invention;

FIG. 8 is a circuit explaining the operation of a sensing block according to an embodiment of the present invention;

FIG. 9 is a circuit explaining the principle of the operation of a charge amplifier according to an embodiment of the present invention;

FIG. 10 is a circuit illustrating the configuration a charge amplifier according to an embodiment of the present invention;

FIG. 11 is a view explaining the feedback operation of the charge amplifier according to an embodiment of the present invention; and

FIG. 12 is view showing readout of a touch area when a comparator having a 1-bit resolution is used according to an embodiment of the present invention.

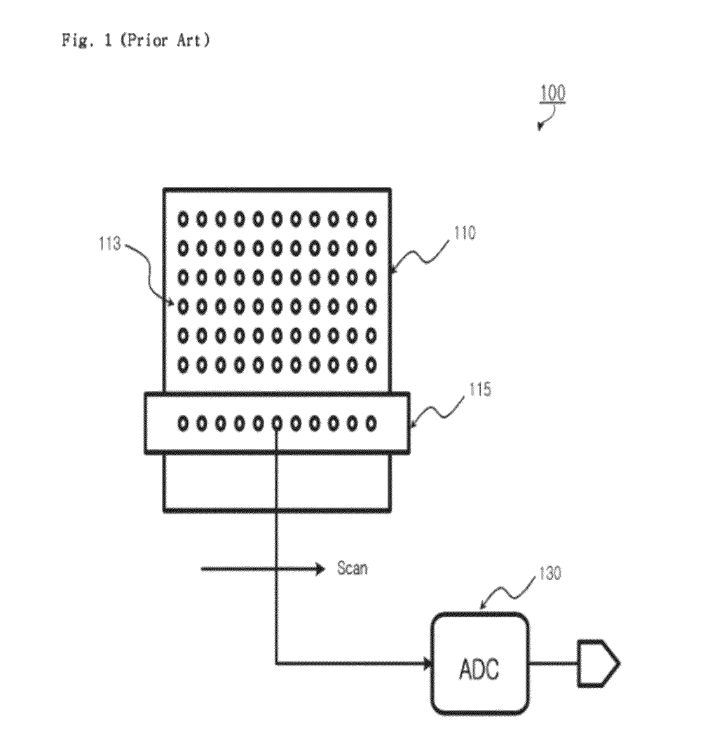

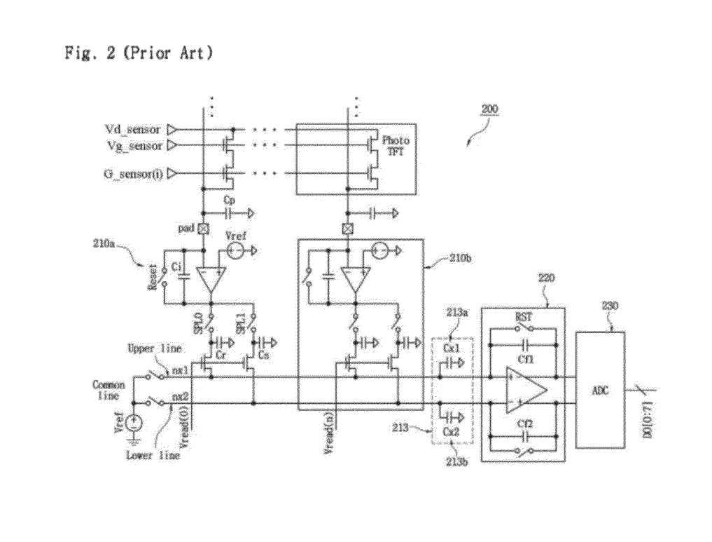

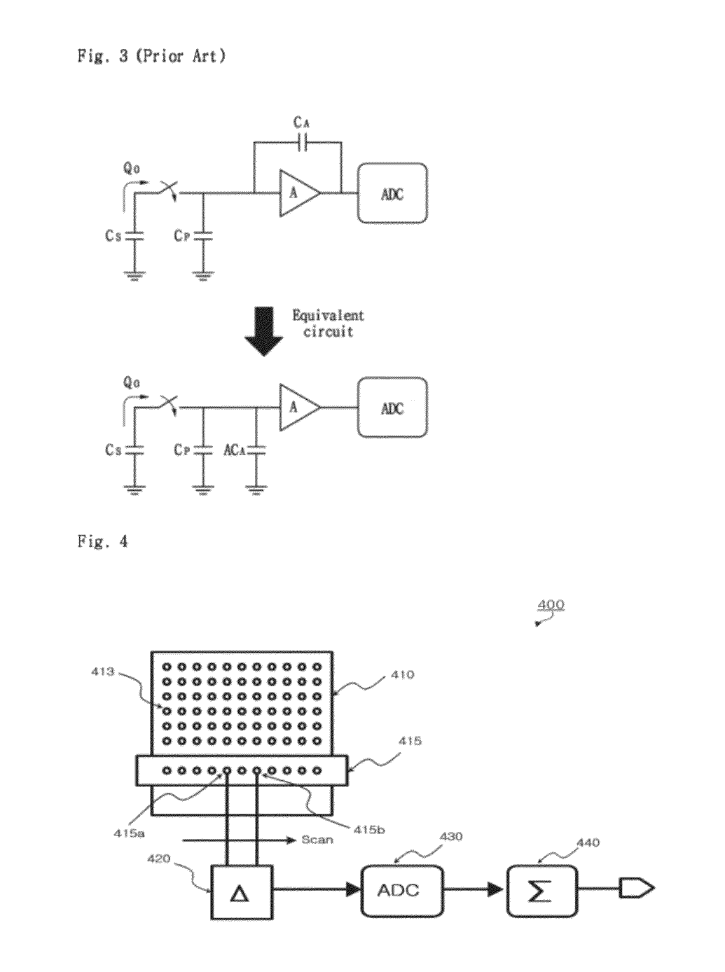

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

FIG. 4 is a view illustrating a conception of a readout integrated circuit (ROIC) for a touch screen based on a sigma-delta principle according to an embodiment of the present invention.

Referring to FIG. 4, the readout integrated circuit includes a touch screen panel (TSP) 410, touch sensors 413 arranged in the form of a matrix having rows and columns, and an analog-to-digital converter (ADC) 430, similar to the conventional readout integrated circuit.

However, differently from the conventional readout integrated circuit which scans the coordinates of every touch sensor one by one, the readout integrated circuit according to an embodiment of the present invention is configured in such a manner as to select two touch sensors 415a and 415b spaced by a predetermined distance from each other, to sequentially compare voltage output values of two selected touch sensors while moving one column by one column, and to perform an analog-to-digital conversion operation on each difference value (hereinafter, referred to as a “delta (Δ) voltage”) between the respective compared voltage output values.

Specifically, the predetermined distance means a distance between a first touch sensor and a touch sensor other than touch sensors directly next to the first touch sensor. The readout integrated circuit performs a reading operation on a row up to the end there while sequentially moving at an interval of the predetermined distance, and, when completing a scanning operation with respect to a selected row, performs a scanning operation with respect to the next row in the same manner, too.

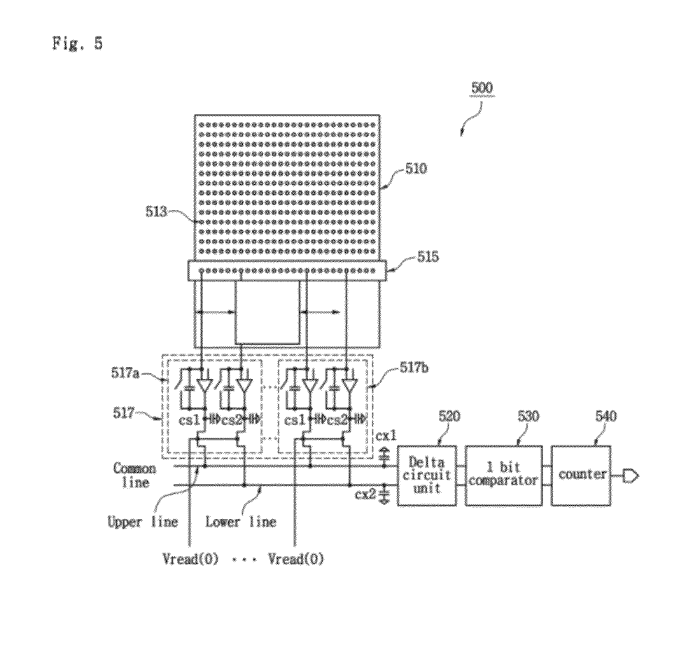

FIG. 5 is a circuit illustrating the configuration of a readout integrated circuit (ROIC) for a touch screen based on a sigma-delta principle, which is configured to process a 1-bit signal, according to an embodiment of the present invention. Referring to FIG. 5, the readout integrated circuit 500 for a touch screen according to an embodiment of the present invention includes a touch screen panel (TSP) 510, a touch sensor unit 513, a sensing block unit 517, a delta circuit unit 520, a 1-bit comparator 530, and a counter 540. The touch sensor unit 513 includes a plurality of touch sensors, which are arranged in the form of a matrix having rows and columns, in the inside or outside of the touch screen panel 510. The sensing block unit 517 includes a plurality of sensing blocks 517a, . . . , 517b, which sense an electrical change in each touch sensor, convert the sensed electrical change into a voltage value, and store the voltage value. The delta circuit unit 520 receives a difference between two sensing voltage values, which are stored in two sensing blocks, respectively, selected at a predetermined distance, and then creates a delta (Δ) voltage. The 1-bit comparator 530 performs a signal processing in such a manner as to convert an analog signal output from the delta circuit unit 520 into a 1-bit digital signal. The counter 540 accumulatively performs an addition operation or a subtraction operation with digital signals output from the 1-bit comparator 530.

Here, the delta circuit unit 520 may further include a charge amplifier in order to prevent a loss of a delta (Δ) voltage due to a parasitic component when the delta (Δ) voltage created by the delta circuit unit 520 is applied to the input terminal of an analog-to-digital converter, but the present invention is not limited thereto and may be modified in a variety of ways.

Hereinafter, a method for implementing a sigma-delta principle with the sensing block unit 517 and the counter 540, and detecting an edge of a touch area will be described in detail.

The sensing block unit 517 converts an electrical change of touch information, which is sensed by each of all the touch sensors in one row, into a voltage, and stores the voltage in an upper sampling capacitor C_{S1} connected to an upper line of a common line, and a lower sampling capacitor C_{S2} connected to a lower line of the common line, respectively.

Here, the reason why the difference (Δ) of output values having the same value is stored in both upper sampling capacitor C_{S1} and lower sampling capacitor C_{S2} is that, as a scanning operation is performed, a total of two comparison operations with respect to one touch sensor, that is, a first comparison between the one touch sensor and another touch sensor spaced by a predetermined distance to the left of the one touch sensor, and a second comparison between the one touch sensor and another touch sensor spaced by a predetermined distance to the right of the one touch sensor, are performed.

In order to take a difference between voltages stored in two sensing blocks spaced by a predetermined distance from each other among the plurality of sensing blocks 517a to 517b, a difference (Δ) between output voltages of the two sensing blocks, stored in each of the upper sampling capacitor C_{S1} and lower sampling capacitor C_{S2}, is applied to a charge amplifier, is amplified, and is input to the 1-bit comparator 530.

In the case of comparing two touch sensors according to an embodiment of the present invention, when two comparison points are all located in the inside of a touch area or are all located in the outside of the touch area, the output voltage values of sensing blocks of the two touch sensors are the same in the ideal case, so that the delta (Δ) becomes zero.

However, actually, the delta (Δ) does not become zero due to common noise and mismatching between sensors, and a general comparator generates a triggering event even when the delta (Δ) has a value a little higher than zero. Therefore, it is preferred to use a dead-zone comparator 530, which has a dead zone in triggering thereof, in place of a general comparator.

Since an output of the dead-zone comparator 530 is generated only with respect to delta (Δ) values exceeding the range of the dead zone among delta (Δ) values input to the dead-zone comparator 530, the counter 540 accumulatively performs an addition operation or a subtraction operation only with respect to the delta (Δ) values exceeding the range of the dead zone.

The dead zone according to an embodiment of the present invention means a range of input voltages for a comparator, which is set to prevent the comparator from operating by a small value within a predetermined range. Since the dead zone must have a range including a delta (Δ) value caused by noise, it is preferred that the dead zone varies depending on external circumstances and/or touch panel configurations.

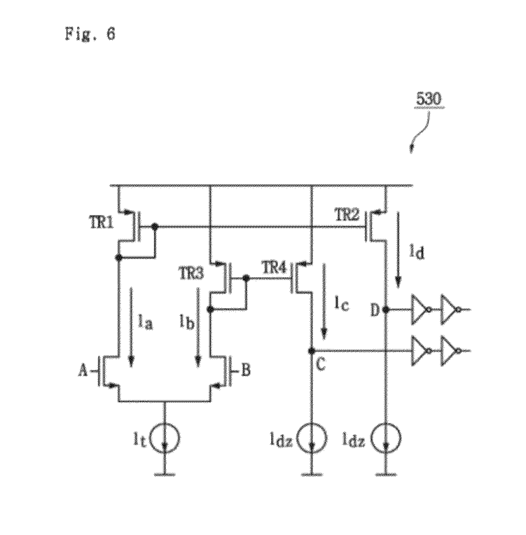

FIG. 6 is a circuit of a dead-zone comparator in which it is possible to adjust a dead zone by varying current according to an embodiment of the present invention.

Referring to FIG. 6, transistors TR1 and TR2 form a current mirror, and allow constant currents Ia and Id of the same level to flow to transistor A and node D, respectively. Also, transistor TR3 and TR4 also form a current mirror, and allow constant currents Ib and Ic of the same level to flow through transistor B and node C, respectively.

Hereinafter, the operation of adjusting a dead zone by varying a dead-zone constant current Idz will be described.

For example, it is assumed that tail current It obtained by adding current Ia of input transistor A and current Ib of input transistor B is 5 μA, and first dead-zone constant current Idz and second dead-zone constant current Idz flowing through nodes C and D, respectively, have the same current value of 3 μA.

Since tail current It at the lower sides of input transistors A and B is 5 μA, each of currents Ia and Ib is 2.5 μA, and each of currents Ic and Id shown on the right side of FIG. 5B becomes 2.5 μA by the current mirrors, too. However, since the dead-zone constant current shown on the lower side of the drawing is 3 μA, nodes C and D drop to a low level, respectively.

If current Ia of input transistor A is 4 μA, and current Ib of input transistor B is 1 μA, current Ic becomes 1 μA and current Id becomes 4 μA by the current mirrors. Accordingly, in this case, while node C is in the low level because current less than dead-zone constant current Idz of 3 μA flows through node C as before, node D transitions to a high level because current greater than dead-zone constant current Idz of 3 μA flows through node D.

That is, current less than 3 μA which is dead-zone constant current Idz is input, the outputs of corresponding nodes C and D are always in the low level. Next, when input current increase, and current Ia or Ib becomes greater than 3 μA, either node C or node D transitions to the high level.

While the above description has been described about the case where the dead-zone constant current Idz is 3 μA, the dead-zone constant current Idz may change to have an optimum value in consideration of a delta level caused by noise.

Preferably, in order to make the output voltages of nodes C and D more sharp, an inverter may be installed on each output side thereof.

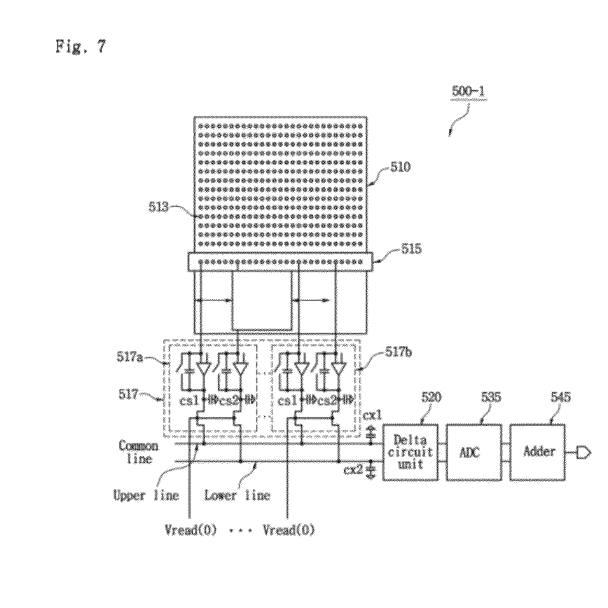

FIG. 7 is a circuit illustrating the configuration of a readout integrated circuit (ROIC) for a touch screen based on a sigma-delta principle, which is configured to process a multi-bit signal having two or more bits, according to an embodiment of the present invention.

The readout integrated circuit shown in FIG. 7 will now be described in comparison with the readout integrated circuit shown in FIG. 5. The readout integrated circuit shown in FIG. 5C has the same configuration as that shown in FIG. 5, except that that readout integrated circuit shown in FIG. 7 includes an analog-to-digital converter (ADC) 535 having a resolution of two or more bits in place of the comparator having a 1-bit resolution in order to increase sensitivity, and includes an adder 545 in place of the counter 540, so a detailed description on the same components will be omitted.

In this case, it is preferred to set a threshold value, similar to the conception of the dead zone described with reference to FIG. 5, so that the adder 545 can filter output values of the analog-to-digital converter 535 caused by noise, and to design the readout integrated circuit such that an addition operation or a subtraction operation can be performed with respect to output values greater than the set threshold value among output values of the analog-to-digital converter 535.

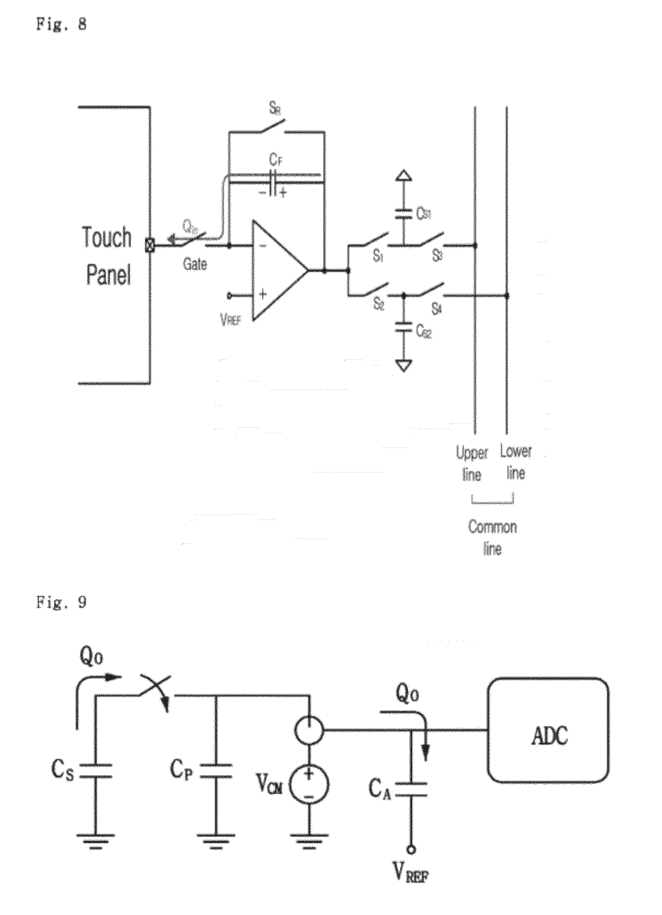

FIG. 8 is a circuit explaining the operation of a sensing block according to an embodiment of the present invention.

Referring to FIG. 8, the sensing block according to an embodiment of the present invention is an amplification circuit including an operational amplifier (OP Amp) and a capacitor, wherein, when gate switches S1 and S2 are open, charge Qin flows into a touch panel or flows out from the touch panel, so that feedback capacitor C_{F} is charged with a voltage depending on the flow of the charge Qin.

There is a difference in the amount of movement of charge between in a touched area and in a non-touched area. If a larger amount of charge flows in a touched area, a relatively larger amount of charge is charged in feedback capacitor C_{F} in the touched area, as compared with the non-touched area, so that the voltage of the output terminal of the operational amplifier (OP Amp) varies depending on whether or not a touch is applied.

The aforementioned procedure is performed on all touch sensors included in a selected row at the same time, so that the voltage of the output terminal of the operational amplifier (OP Amp) is also stored in the upper sampling capacitor C_{S1} and lower sampling capacitor C_{S2}, respectively, at the same time.

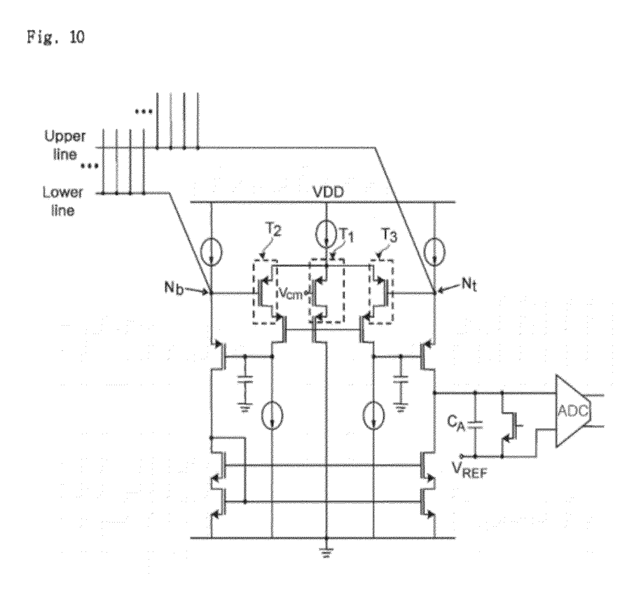

FIG. 9 is a circuit explaining the principle of the operation of a charge amplifier according to an embodiment of the present invention.

Referring to FIG. 9, according to an embodiment of the present invention, the charge amplifier does not use an operational amplifier (OP Amp), maintains a common-mode voltage V_{CM} for the upper line and lower line of a common line at the common-mode voltage V_{CM} using an internal feedback circuit, charges a storing capacitor C_{A} of a single output terminal by a difference Q₀ between first charge amount Q1 input from the upper line and second charge amount Q2 input from the lower line, and then generates a voltage. Accordingly, charge from the upper sampling capacitor C_{S1} and lower sampling capacitor C_{S2} of a sensing block is not charged in parasitic capacitor C_{P} parasitizing in a common line, and a node voltage unconditionally converges into a common-mode voltage V_{CM} by feedback even if the node voltage rises momentarily.

The output V_{O} of the charge amplifier is expressed as Equation 2 below. Referring to Equation 2, it can be understood that the output of the charge amplifier is not influenced by parasitic capacitor C_{P}.

$${V}_{O} = \frac{{Q}_{O}}{{C}_{A}} \qquad ( 2 )$$

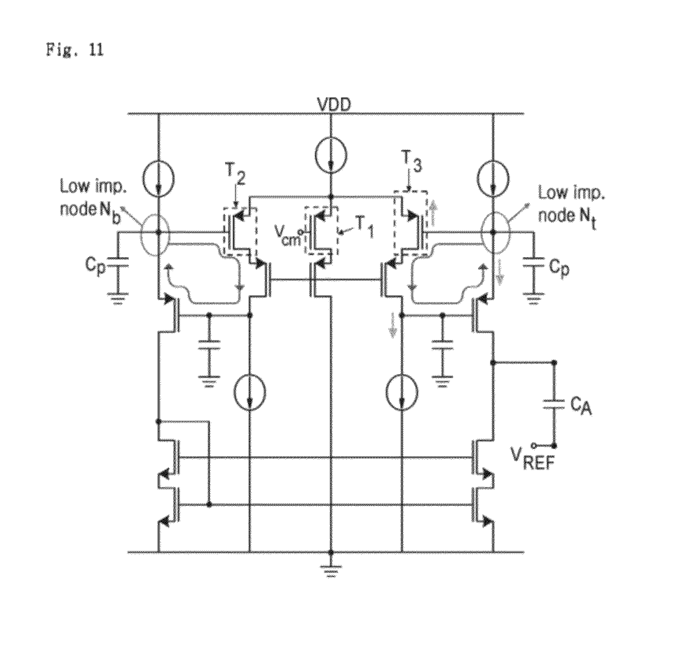

FIG. 10 is a circuit illustrating the configuration of a charge amplifier according to an embodiment of the present invention, and FIG. 11 is a view explaining the feedback operation of the charge amplifier according to an embodiment of the present invention.

Referring to FIG. 10, node Nt is connected to an upper line, and node Nb is connected to a lower line.

The charge amplifier includes a first PMOS transistor T1, to the gate of which a common-mode voltage V_{CM} is applied, and second and third PMOS transistors T2 and T3, respectively, which are located at both sides of the first PMOS transistor T1. When the bias currents flowing through the first, second, and third PMOS transistors, respectively, are the same, voltages Vgs applied between the gates (G) and sources (S) of the respective PMOS transistors become the same, so that node Nt and node Nb always have the same voltage as the common-mode voltage V_{CM} by feedback.

While the present invention has been described about a method of allowing nodes Nt and Nb to always have the same voltage as the common-mode voltage V_{CM} through the use of the first, second, and third PMOS transistors, the present invention is not limited thereto, and the method may be implemented through the use of first, second, and third NMOS transistors.

Hereinafter, the feedback operation of the charge amplifier according to an embodiment of the present invention will be described with reference to FIG. 11.

First, the following description will be given on a feedback operation with respect to node Nt shown in the right side of FIG. 11.

When charge moves from a storing capacitor C_{A} of a sensing block to node Nt, and the voltage of node Nt rises suddenly, voltages change as expressed by yellow arrows along a red path, so that the circuit operates to drop the voltage of node Nt, which has risen, and the moving charge moves to be charged in the storing capacitor C_{A}.

The feedback operation of node Nb shown in the left side of FIG. 11 is the same as that of node Nt in the right side thereof. However, since charge of node Nb is input to a storing capacitor C_{A} in the opposite direction of the movement direction of the charge of Node Nt, the storing capacitor C_{A} is charged with a difference Q₀ between charge amounts input to nodes Nt and Nb, that is, with a difference Q₀ between two charge amounts input through upper line and lower lines.

Since the charge amplifier according to an embodiment of the present invention has a configuration such that a reference voltage V_{ref} is connected to the lower terminal of a capacitor of an output terminal, the voltage of only the upper terminal of the storing capacitor C_{A} varies when charge is charged in the storing capacitor C_{A}, which corresponds to the structure of a single output amplifier. Therefore, it can be understood that a Common Mode Feedback (CMFB) circuit, which has been required in the conventional differential output amplifier, is not required.

According to the charge amplifier based on an embodiment of the present invention, a negative feedback is applied to produce a high loop gain in the charge amplifier, so that it is possible to make a common line with a much lower impedance node than that used in the conventional charge amplifier. That is, the common-mode voltage V_{CM} of the common line can be maintained at a stable value which is almost unchanged.

In more detail, in the case of the conventional charge amplifier, when the transconductance of an operational transconductance amplifier (OTA) itself is Gm, the node impedance of a common line is no more than

$$\frac{1}{{G}_{m}} .$$

In contrast, the loop gain of a negative loop of the charge amplifier according to an embodiment of the present invention is expressed as Equation 3 below.

$$LG = \frac{\frac{1}{2} {g}_{m} {r}_{o}^{2}}{\frac{2}{{g}_{m}}} = \frac{1}{4} {g}_{m}^{2} {r}_{o}^{2} \qquad ( 3 )$$

Since the impedance of a common-line node, at which feedback is not made, is approximately 1/gₘ, feedback provides an effect of dividing 1/gₘ by “1+LG,” i.e. by approximately LG.

Therefore, the impedance Z_{CM} of a common-line node is expressed as Equation 4 below.

$${Z}_{CM} = \frac{1}{{g}_{m}} \cdot \frac{4}{{g}_{m}^{2} {r}_{o}^{2}} = \frac{4}{{g}_{m}^{3} {r}_{o}^{2}} \qquad ( 4 )$$

Accordingly, it can be understood that, since the charge amplifier according to an embodiment of the present invention can obtain a very high loop gain by applying a feedback in the charge amplifier, impedance becomes significantly lower than that of the conventional amplifier, so that the common-mode voltage V_{CM} of the common line has a stable value.

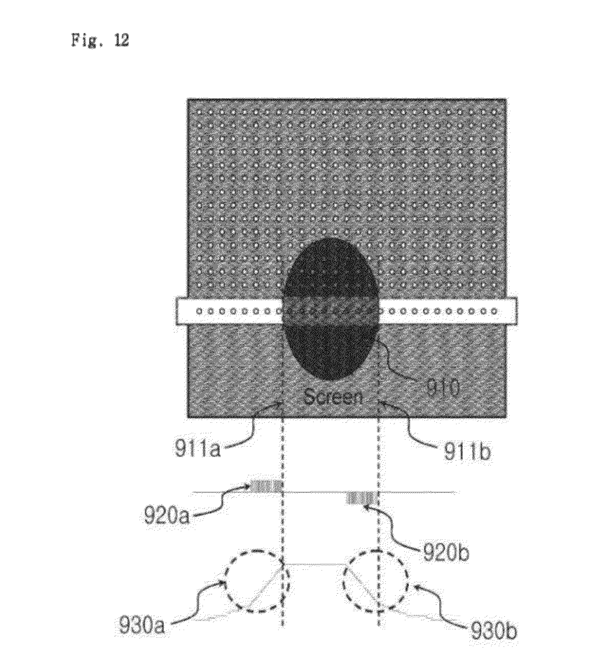

FIG. 12 is view showing readout of a touch area when a comparator having a 1-bit resolution is used according to an embodiment of the present invention.

Referring to FIG. 12, the comparator having a 1-bit resolution according to an embodiment of the present invention does not operate in a touched area 910 and a non-touched area, but operates in boundary sections 911a and 911b between the two areas. That is, a positive pulse group and a negative pulse group are formed at both sides of the boundary section of a touch area. With respect to a positive pulse group 920a output through the comparator, an accumulative addition operation is performed through the counter 540 (See reference number 930a). With respect to a negative pulse group 920b output through the comparator, an accumulative subtraction operation is performed through the counter 540 (See reference number 930b).

While the procedure has been described with respect to a comparator having a 1-bit resolution, the present invention is not limited thereto, and the procedure may be applied even to an analog-to-digital converter (ADC) having a resolution of two or more bits. When an analog-to-digital converter (ADC) having a resolution of two or more bits is used, it is preferred to use an adder having a dead-zone function for filtering a digital output due to noise among outputs of the ADC, like the dead-zone function of the comparator, as described above.

As is apparent from the above description, the present invention provides a readout integrated circuit (ROIC), which efficiently removes effects caused by common noise or mismatching between sensors, enhances the sensitivity, thereby remarkably reducing the resolution of the analog-to-digital converter (ADC).

Also, according to an embodiment of the present invention, the readout integrated circuit (ROIC) can be configured such that the node impedance of a common line has a remarkably smaller value than that of the conventional readout integrated circuit, so that it is possible to easily design a charge amplifier having a broad bandwidth.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A readout integrated circuit (ROIC) for a touch screen, the readout integrated circuit comprising:
a touch sensor unit configured to comprise a plurality of touch sensors which are arranged in a matrix form having rows and columns in an inside or outside of a touch screen panel (TSP);
a plurality of sensing blocks configured to sense an electrical change in each of the touch sensors, to convert the electrical change into a voltage value, and to store the voltage value;
a delta circuit unit configured to receive a difference between two sensing voltage values stored in two sensing blocks, respectively, which are spaced by a predetermined distance and selected from among the plurality of sensing blocks, and to produce a delta (Δ) voltage; and
an analog-to-digital converter (ADC) configured to convert an analog signal output from the delta circuit unit into an N-bit digital signal (wherein, “N” is a natural number).

2. The readout integrated circuit according to claim 1, further comprising a charge amplifier configured to prevent a loss of the delta (Δ) voltage due to a parasitic component when the delta (Δ) voltage produced by the delta circuit unit is applied to an input of the analog-to-digital converter (ADC).

3. The readout integrated circuit according to claim 2, wherein the charge amplifier sequentially receives the difference between sensing voltage values through a common line and amplifies the received difference while moving one column by one column.

4. The readout integrated circuit according to claim 1, further comprising a digital processing block which is configured to receive the N-bit digital signal (wherein, “N” is a natural number) output from the analog-to-digital converter (ADC) and to operate the N-bit digital signal.

5. The readout integrated circuit according to claim 4, wherein the digital processing block comprises a calculator which is configured to perform an addition or subtraction operation.

6. The readout integrated circuit according to claim 1, wherein the sensing blocks store an output voltage of each corresponding touch sensor in an upper sampling capacitor connected to an upper line of a common line and in a lower sampling capacitor connected to a lower line of the common line, respectively.

7. The readout integrated circuit according to claim 1, wherein the predetermined distance is defined as a distance between a first touch sensor and a touch sensor other than touch sensors directly next to the first touch sensor.

8. The readout integrated circuit according to claim 2, wherein the charge amplifier does not include an operational amplifier (OP Amp), maintains a common-mode voltage V_{CM} for upper and lower lines of a common line at the common-mode voltage V_{CM} using an internal feedback circuit, charges a storing capacitor of a single output terminal by a difference Q₀ between first charge amount Q1 input from the upper line and second charge amount Q2 input from the lower line, and then generates a voltage.

9. The readout integrated circuit according to claim 1, wherein, when the N-bit digital signal (wherein, “N” is a natural number) is a 1-bit signal, the analog-to-digital converter (ADC) comprises a comparator having a 1-bit resolution.

10. The readout integrated circuit according to claim 5, wherein, when the N-bit digital signal (wherein, “N” is a natural number) is a 1-bit signal, the calculator comprises a counter.

11. The readout integrated circuit according to claim 9, wherein, in the comparator, a dead zone for preventing the comparator from operating due to a small input within a predetermined range is set.

12. The readout integrated circuit according to claim 11, wherein, for the dead zone, a first dead-zone constant current and a second dead-zone constant current, which are connected to first and second output nodes of the comparator, respectively, and have an equal magnitude, are comprised, so that the first and second output nodes operate at a low or high level.

13. The readout integrated circuit according to claim 12, wherein the first output node operates at the high level only when a first output node current flowing through the first output node is greater than the first dead-zone constant current, and the second output node operates at the high level only when a second output node current flowing through the second output node is greater than the second dead-zone constant current.

14. The readout integrated circuit according to claim 12, wherein magnitudes of the first dead-zone constant current and second dead-zone constant current can be adjusted and varied.

15. The readout integrated circuit according to claim 1, wherein, when the N-bit digital signal (wherein, “N” is a natural number) is a two or more-bit signal, the analog-to-digital converter (ADC) comprises an analog-to-digital converter (ADC) having a resolution of two or more bits.

16. The readout integrated circuit according to claim 5, wherein, when the N-bit digital signal (wherein, “N” is a natural number) is a two or more-bit signal, the calculator comprises an adder.

17. The readout integrated circuit according to claim 16, wherein the adder is configured to set a threshold value for filtering output values of the analog-to-digital converter (ADC) caused by noise, and to perform an addition or subtraction operation with respect to only output values greater than the set threshold value among output values of the analog-to-digital converter (ADC).
